(19) United States
(12) Patent Application Publication
(10) Pub. No.: US 2016/0080707 A1
(43) Pub. Date: Mar. 17, 2016

(54) IMAGE PHOTOGRAPHING APPARATUS AND IMAGE PHOTOGRAPHING METHOD THEREOF

(71) Applicant: SAMSUNG ELECTRONICS CO., LTD., Suwon-si (KR)

(72) Inventors: Sang-jin LEE, Seoul (KR); Soon-geun JANG, Suwon-si (KR)

(73) Assignee: SAMSUNG ELECTRONICS CO., LTD., Suwon-si (KR)

(21) Appl. No.: 14/806,033

(22) Filed: Jul. 22, 2015

(30) Foreign Application Priority Data
Sep. 16, 2014 (KR) 10-2014-0122910

(51) Int. Cl. H04N 9/04; G06T 3/40; H04N 9/64; H04N 9/083; H04N 5/235

(52) U.S. Cl. CPC H04N 9/045; H04N 9/083; H04N 5/2352; H04N 5/2351; H04N 9/646; G06T 3/4015; H04N 2209/046; G06T 2207/20012

(57) ABSTRACT

An image photographing apparatus and an image photographing method thereof are provided. The image photographing method includes determining an illuminance of a photograph environment during image photographing; and controlling a resolution of a captured image according to the determined illuminance.

### CROSS-REFERENCE TO RELATED APPLICATIONS

This application claims priority from Korean Patent Application No. 10-2014-0122910, filed on Sep. 16, 2014 in the Korean Intellectual Property Office, the disclosure of which is incorporated by reference herein in its entirety.

### BACKGROUND

1. Field

Apparatuses and methods consistent with exemplary embodiments relate to an image photographing apparatus and an image photographing method thereof, and more particularly, to an image photographing apparatus and an image photographing method thereof, for maintaining image quality of an image even if a user captures an image in an environment with low illuminance.

2. Description of the Related Art

Recently, as an image photographing apparatus has become popular, a cellular phone, a notebook computer, frequently, a personal computer (PC), and so on as well as a camera include an image photographing module so as to provide an image photographing function. Accordingly, as a user is easily exposed to an image photographing function through various electronic devices, user's needs for capturing an image with an image quality that is not affected even if a photographic environment is changed have increased.

That is, an image captured by an image photographing apparatus is affected by a photographic environment. In particular, since the image photographing apparatus captures an image of a target object using light transmitted through a lens to form the photograph, when an optical amount of light in a surrounding environment is not sufficient, the quality of captured image is affected.

Accordingly, there is a need for a method for capturing an image with high quality irrespective of illuminance even if illuminance of an environment in which the image is captured is lowered.

### SUMMARY

Exemplary embodiments overcome the above disadvantages and other disadvantages not described above. Also, the exemplary embodiments are not required to overcome the disadvantages described above, and a given exemplary embodiment may not overcome any of the disadvantages described above.

Exemplary embodiments provide an image photographing apparatus and an image photographing apparatus thereof, for capturing an image while maintaining image quality of an image captured in high illuminance even if a luminance of an image photographing environment using an image photographing apparatus is lowered.

According to an aspect of an exemplary embodiment, there is provided an image photographing method of an image photographing apparatus, the method including determining an illuminance of a photograph environment during image photographing; and controlling a resolution of a captured image according to the determined illuminance.

The controlling may include controlling the resolution of the captured image to be lowered to a threshold resolution in response to the determined illuminance being equal to or less than a first threshold value.

The controlling may include controlling the resolution of the captured image to be proportionally lowered as the determined illuminance decreases.

The image photographing apparatus may include an image sensor, and the controlling the resolution may include merging a subset of a plurality of pixels included in the image sensor.

The controlling may include determining a resolution of the captured image corresponding to the determined illuminance of the photograph environment; analyzing a frequency of a color filter array (CFA) pattern used to capture the captured image; and limiting a frequency band of the CFA pattern according to the determined resolution.

The determining may include analyzing the captured image and determining the illuminance of the photograph environment according to the analysis result.

The image photographing apparatus may include an illuminance sensor, and the determining may include determining the illuminance of the photograph environment using he illuminance sensor.

The image photographing method may further include determining a signal to noise ratio (SNR) of the captured image; and controlling the resolution of the image in response to the SNR of the image being greater than or equal to a threshold value.

The controlling may include lowering the resolution of the captured image to a threshold resolution in response to the SNR of the image being greater than or equal to a first threshold value.

The image photographing method may further include storing the controlled resolution of the captured image in association with the determined illuminance.

The merging may include merging a preset number of neighboring pixels of the plurality of pixels included in the image sensor.

According to another aspect of an exemplary embodiment, there is provided an image photographing apparatus including a photographing module configured to capture an image; and a controller configured to determine an illuminance of a photograph environment during photographing of the image, and to control a resolution of the captured image according to the determined illuminance.

The controller may be configured to control the resolution of the captured image to be lowered to a threshold resolution in response to the illuminance of the photograph environment being equal to or less than a first threshold value.

The controller may be configured to control the resolution of the captured image to be proportionally lowered as the determined illuminance decreases.

The photographing module may include an image sensor including a plurality of pixels; and the controller may be configured to control the resolution of the captured image to be lowered by merging a subset of the plurality of pixels included in the image sensor.

The controller may be configured to determine a resolution of the image corresponding to the determined illuminance of the photograph environment, analyze a frequency of a color filter array (CFA) pattern used to capture the image, and limit a frequency band of the CFA pattern according to the determined resolution.

The controller may be configured to analyze the captured image and determines the illuminance of the photograph environment according to the analysis result.

The image photographing apparatus may further include an illuminance sensor, and the controller may be configured to determine the illuminance using the illuminance sensor.

The controller may be configured to determine a signal to noise ratio (SNR) of the captured image and control the resolution of the image according to the SNR of the image, when the SNR of the image is greater than or equal to a threshold value.

The controller may be configured to lower the resolution of the captured image to a threshold resolution according to the SNR of the image, when the SNR of the image is greater than or equal to a first threshold value.

The image photographing apparatus may further include a storage, and the controller may be configured to control the storage to store the controlled resolution of the captured image in association with the determined illuminance.

The controller may be configured to merge a preset number of neighboring pixels of the plurality of pixels included in the image sensor.

According to an aspect of another exemplary embodiment, there is provided an image photographing apparatus including a photographing module including an image sensor, the photographing module configured to capture an image; and a controller configured to merge a subset of a plurality of pixels of the image sensor in response to an illuminance of an environment of the image to be captured being less than or equal to a threshold illuminance.

The controller may be configured to merge a number of neighboring pixels of the plurality of pixels of the image sensor.

The controller may be configured to merge a target pixel, a pixel positioned to the left of the target pixel, a pixel positioned below the target pixel, and a pixel positioned below the pixel positioned to the left of the target pixel.

The controller may be configured to merge a target pixel, a pixel positioned adjacent and to the left of the target pixel, a pixel positioned adjacent and below the target pixel, and a pixel positioned adjacent and below the pixel positioned to the left of the target pixel.

### BRIEF DESCRIPTION OF THE DRAWING FIGURES

The above and/or other aspects will be more apparent by describing certain exemplary embodiments with reference to the accompanying drawings, in which:

FIG. 1 is a block diagram illustrating a configuration of an image photographing apparatus according to an exemplary embodiment;

FIG. 2 is a block diagram illustrating a configuration of an image photographing apparatus in detail according to an exemplary embodiment;

FIG. 3 is a flowchart of a method of controlling an image photographing apparatus according to an exemplary embodiment;

FIG. 4 is a flowchart of an image photographing method of an image photographing apparatus according to an exemplary embodiment;

FIG. 5 is a flowchart illustrating a method of controlling resolution and processing a signal according to resolution by an image photographing apparatus according to an exemplary embodiment;

FIG. 6 is a graph obtained by analyzing Bayer data and frequency characteristics according to an exemplary embodiment;

FIG. 7 is a graph for explaining a new Nyquist frequency according to resolution control according to an exemplary embodiment; and

FIG. 8 is a graph for explaining an effect of limiting of a frequency band according to an exemplary embodiment.

### DETAILED DESCRIPTION OF EXEMPLARY EMBODIMENTS

Hereinafter, exemplary embodiments will be described with reference to the attached drawings. In the description, certain detailed explanations of related art are omitted when it is deemed that they may unnecessarily obscure the essence of the inventive concept. The terms used in the specification are defined in consideration of functions used in the exemplary embodiments, and can be changed according to the intent or conventionally used methods of clients, operators, and users. Accordingly, definitions of the terms should be understood on the basis of the entire description of the present specification.

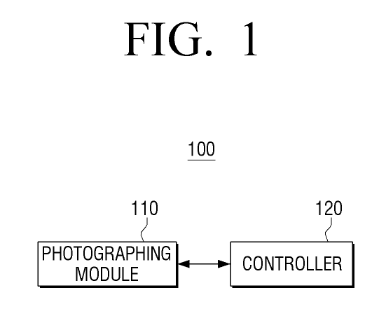

FIG. 1 is a block diagram illustrating a configuration of an image photographing apparatus according to an exemplary embodiment. As illustrated in FIG. 1, an image photographing apparatus 100 may include a photographing module 110 and a controller 120. In this case, the image photographing apparatus 100 is embodied as a camera as an exemplary embodiment. However, the image photographing apparatus 100 may be embodied as various electronic apparatuses including the photographing module 110, such as a cellular phone, a tablet personal computer (PC), a digital camera, a camcorder, a notebook PC, a personal digital assistant (PDA), and so on.

The photographing module 110 is a component for capturing an image. That is, the photographing module 110 may convert an optical signal input through a lens into an electrical signal through an image sensor and receive an image of a target object. In this case, the target object refers to any object. The object may include a main target object and a background in a generated captured image.

The controller 120 is a component for controlling an overall operation of the image photographing apparatus 100. The controller 120 may be, for example, one or more microprocessors or microcontrollers. In particular, the controller 120 may determine an illuminance of an environment of a photograph (i.e., a photograph environment) while an image is captured through the photographing module 110, and control a resolution of the captured image according to the illuminance of the photograph environment.

The controller 120 may analyze the captured image and determine an illuminance of the photograph environment according to the image analysis result. In addition, the controller 120 may determine the illuminance of the photograph environment using an illuminance sensor included in the image photographing apparatus 100.

As the determination result, when the illuminance of the photograph environment is equal to or less than a first threshold value, the controller 120 may control a resolution of the captured image to be lowered to a threshold resolution. The threshold resolution may be preset. In addition, the controller 120 may control the resolution of the image to be proportionally lowered as the determined illuminance of the photograph environment is lowered.

In particular, the controller 120 may merge various pixels to lower a resolution of the image with respect to a plurality of pixels included in an image sensor of the photographing module 110 for capturing an image. That is, the controller 120 may merge a subset of the plurality of pixels included in the image sensor to lower the resolution of the image. For example, the controller 120 may merge a plurality of neighboring pixels. The number of neighboring pixels merged may be preset.

In detail, the controller 120 may control a resolution by calculating a resolution of the image corresponding to the determined illuminance of the photograph environment, analyzing a frequency of a color filter array (CFA) pattern, and limiting a frequency band of the CFA pattern according to the calculated resolution.

The controller 120 may perform control to match and store the resolution of the captured image according to the determined illuminance, with the determined illuminance. That is, the controller 120 may store the resolution of the captured image in association with the determined illuminance.

The controller 120 may determine a signal to noise ratio (SNR) instead of a method of measuring an illuminance of a photograph environment. Alternatively, the controller 120 may determine a SNR together with a method of measuring the illuminance. The controller 120 may control the resolution according to the determination result.

That is, upon determining the SNR of the captured image and determining that the SNR of the image is greater than or equal to a threshold value according to the analysis result, the controller 120 may control the resolution of the image captured through the photographing module 110.

In detail, upon determining that the SNR of the image is greater than or equal to a first threshold value, the controller 120 may perform control to lower a resolution of the captured image to threshold resolution. The threshold resolution may be preset.

Through the aforementioned image photographing apparatus 100, a user may acquire an image with high quality like an image captured in high illuminance even if an illuminance of a photograph environment of an image is lowered.

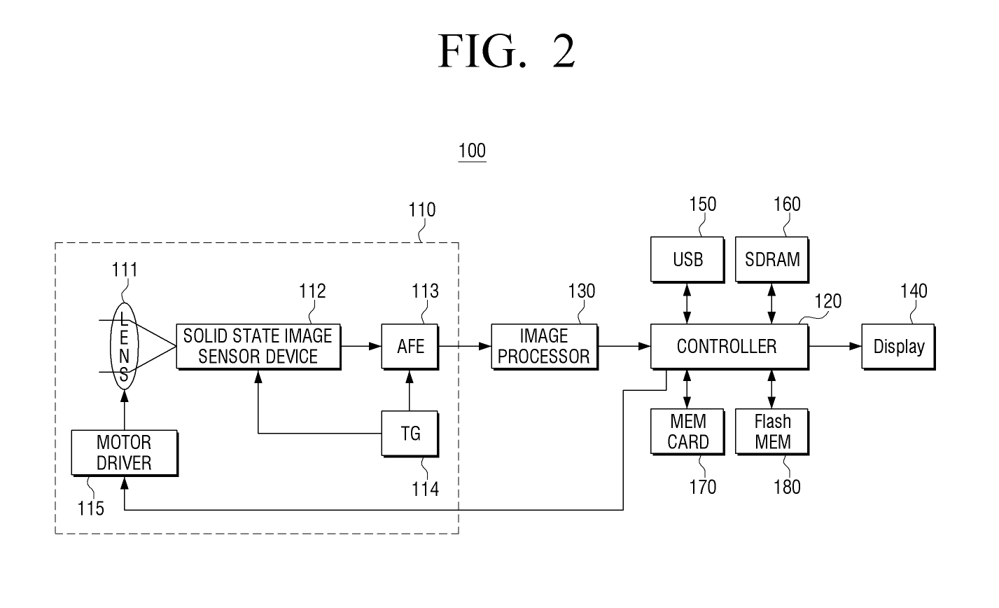

As illustrated in FIG. 2, the image photographing apparatus 100 may include an image processor 130, a display 140, a universal serial bus (USB) 150, a synchronous dynamic RAM (SDRAM) 160, a memory (MEM) card 170, and a flash memory (MEM) 180 in addition to the photographing module 110 and the controller 120.

In addition, the photographing module 110 as a component for capturing an image may include a lens 111, a solid state image sensor device 112, a timing generator (TG) 114, an analog front end (AFE) 113, and a motor driver 115.

The lens 111 may be a component on which light reflected by a target object is incident and may include at least one of a zoom lens and a focus lens. In addition, the image photographing apparatus 100 may further include an iris (not shown).

The iris is a component that adjusts the amount of light that passes through the lens 111 and is incident on the image photographing apparatus 100.

The solid state image sensor device 112 is a component for forming an image of a target object, transmitted through the lens 111. The solid state image sensor device 112 may include a photo diode (PD), a transmission transistor (TX), a reset transistor (RX), and a floating diffusion node (FD).

In detail, the solid state image sensor device 112 is a component for forming the image of the target object, transmitted through the lens 111. The solid state image sensor device 112 includes a plurality of pixels arranged in a matrix form. Each of the plurality of pixels accumulates photocharges according to incident light and outputs an image based on the photocharges as an electrical signal. The solid state image sensor device 112 may be a charge coupled device (CCD), a complementary metal oxide semiconductor (CMOS), or the like.

According to an exemplary embodiment, the image photographing apparatus 100 may merge various pixels of the solid state image sensor device 112 according to an illuminance of a photograph environment, and capture an image according to control of the controller 120. In detail, upon determining that the illuminance of the photograph environment is equal to or less than a threshold value, the controller 120 may control the solid state image sensor device 112 to merge various pixels among the plurality of pixels of the solid state image sensor device 112 and to output an electrical signal according to the photocharges. That is, the controller 120 may control the solid state image sensor device 112 to merge a subset of the plurality of pixels of the solid state image sensor device 112. For example, the controller 120 may control the solid state image sensor device 112 to merge a plurality of neighboring pixels among the plurality of pixels of the solid state image sensor device 112. The number of the pixels to be merged may be preset, or may be adaptively determined.

That is, when the illuminance of the photograph environment is low, the solid state image sensor device 112 may merge various pixels among a plurality of pixels of the solid state image sensor device 112 such that the merged pixels operate like one pixel.

The TG 114 outputs a timing signal for reading out pixel data of the solid state image sensor device 112.

The AFE 113 sample and digitizes an electrical signal on the image of the target object, output from the solid state image sensor device 112.

However, substitutes may be designed to replace the AFE 113 and the TG 114. In particular, when the solid state image sensor device 112 is configured with a CMOS type, the AFE 113 and the TG 114 may be omitted.

The motor driver 115 focuses the image photographing apparatus 100 by driving a focusing lens. However, when the image photographing apparatus 100 is embodied as a smart phone or a cellular phone, focusing may be processed in terms of software without driving a focus lens, and thus the motor driver 115 may be omitted.

The controller 120 controls a plurality of devices to control an overall operation of the image photographing apparatus 100. The controller 120 image-processes raw image data and records the raw image data in the SDRAM 160. In addition, the controller 120 displays the image-processed data of the SDRAM 160 on the display 140.

In particular, the controller 120 may determine an illuminance of a photograph environment of an image and control a resolution of an image captured according to the determined illuminance of the photograph environment.

In order to determine the illuminance of the photograph environment, the controller 120 may analyze the captured image and determine the illuminance of the photograph environment according to the image analysis result. In addition, the controller 120 may determine the illuminance of the photograph environment using a separate illuminance sensor (not shown) included in the image photographing apparatus 100.

As the determination result, when the illuminance of the photograph environment is equal to or less than a first threshold value, the controller 120 may control a resolution of the captured image to be lowered to a threshold resolution. The threshold resolution may be preset, or may be adaptively set. In addition, the controller 120 may control the resolution of the image to be proportionally lowered as the determined illuminance of the photograph environment decreases.

In particular, the controller 120 may merge various pixels to lower a resolution of the image with respect to a plurality of pixels included in the image sensor of the photographing module 110 for capturing an image. For example, the controller 120 may merge a preset number of neighboring pixels to lower the resolution.

For example, the controller 120 may control a resolution of the captured image to be lowered by merging an arbitrary pixel, a pixel positioned on the left of the target pixel, a pixel positioned below the target pixel, and a pixel positioned below a left portion of the target pixel (i.e., four pixels are merged like one pixel). That is, the controller 120 may merge four pixels to operate like one pixel with respect to a plurality of pixels included in the solid state image sensor device 112 to control resolution of the captured image.

However, the case in which four pixels of the plurality of pixels are merged is only an example, and the number of pixels merged may be more or less than four. For example, the controller 120 may determine the number of pixels to be merged according to a calculated resolution.

The controller 120 may control the resolution by calculating a resolution of the image corresponding to the determined illuminance of the photograph environment, analyzing a frequency of a color filter array (CFA) pattern, and limiting a frequency band of the CFA pattern according to the calculated resolution.

The controller 120 may perform control to match and store a resolution of the captured image according to the determined illuminance, with the determined illuminance. That is, the controller 120 may store a resolution in association with the determined illuminance. That is, the controller 120 may match and store information about a resolution of the image, calculated by the illuminance of the photograph environment. Accordingly, when an image is captured in the future in the photograph environment in which photograph has been performed, the controller 120 may rapidly control a resolution of an image using information about the pre-stored resolution of the image.

The controller 120 may determine a signal to noise ratio (SNR) instead of a method of measuring illuminance of a photograph environment. Alternatively, the controller 120 may determine an SNR together with a method of measuring illuminance. The controller 120 may control a resolution according to the determination result.

That is, upon determining the SNR of the captured image and determining that the SNR of the image is greater than or equal to a threshold value according to the analysis result, the controller 120 may control a resolution of the image captured through the photographing module 110.

In detail, upon determining that the SNR of the image is greater than or equal to a first threshold value, the controller 120 may perform control to lower resolution of the captured image to threshold resolution. The threshold resolution may be preset.

The image processor 130 is a component for processing an image. The image processor 130 may perform various image processing operations such as live-view generation, image resolution control, scaling, color and contrast control, pixel interpolation, cutting, overlapping, etc.

The USB module 150 provides an interface with an external device. When the USB module 150 is connected to a PC or other external devices through a USB cable, the USB module 150 processes transmitting and reception of image data. In addition, the USB module 150 processes transmission and reception of firmware for performing firmware upgrading.

The SDRAM 160 is used to store an image or to perform an image process through a CPU. According to an exemplary embodiment, a DDR SDRAM that can provide output on both rising and falling edges of a system clock may be used to enhance the output. For example, the output may be twice as fast as a case in which output is provided only on the rising edge.

The flash memory 180 stores a firmware program, various adjustment information items appropriate for specification of the image photographing apparatus 100, setting information of the image photographing apparatus 100 according to user input, a captured image file, and so on.

The memory card 170 includes a flash memory and is detachable from the image photographing apparatus 100. The memory card 170 may store a captured image file.

The display 140 is a component for displaying at least one of a user interface including a text, an icon, and so on, electronic information, a live-view image, a dynamic image, and a still image, etc. In addition, the display 140 may perform a function of an electronic viewfinder.

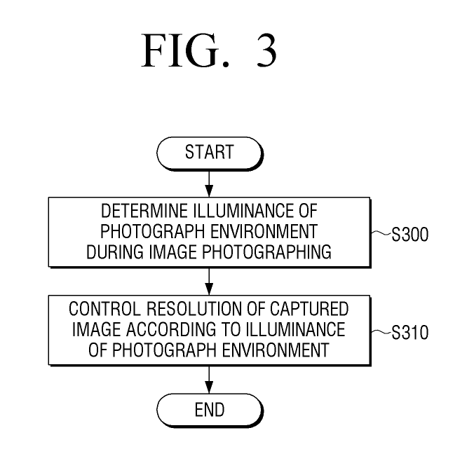

Hereinafter, a method of controlling resolution of an image according to an image photograph environment and capturing an image will be described in detail with reference to flowcharts of FIGS. 3 to 5.

FIG. 3 is a flowchart of a method of controlling the image photographing apparatus 100 according to an exemplary embodiment. The image photographing apparatus 100 determines an illuminance of a photograph environment during image photographing (S300). An operation of capturing an image by the image photographing apparatus 100 may be interpreted as including an operation of accumulating photocharges by a plurality of pixels included in the solid state image sensor device 112 and outputting an image based on the photocharges as an electronic signal, an operation of displaying an image processed as a live view on the display 140, and/or an operation of capturing a live view image according to a user command.

The image photographing apparatus 100 may analyze an image signal during image photographing and determine an illuminance of an environment of the photograph (i.e., a photograph environment). For example, the image photographing apparatus 100 may use a method of calculating an average of pixels of a captured image and determining the illuminance of the photograph environment based on the calculated average. In addition, the image photographing apparatus 100 may determine the illuminance of the photograph environment while adjusting exposure for auto exposure (AE).

The image photographing apparatus 100 may include an illuminance sensor (not shown). Accordingly, the image photographing apparatus 100 may detect the illuminance of the photograph environment through the illuminance sensor (not shown).

The image photographing apparatus 100 controls resolution of a captured image according to the illuminance of the photograph environment (S310). That is, upon determining that an optical amount of the photograph environment is not sufficient and illuminance is low, the image photographing apparatus 100 may control resolution of an image to be lowered.

In detail, the image photographing apparatus 100 may merge various pixels among a plurality of pixels included in the solid state image sensor device 112 and control a resolution of the captured image to be lowered. For example, the image photographing apparatus 100 may merge a plurality of neighboring pixels. The number of pixels merged may be preset, or determined adaptively. As an example, the image photographing apparatus 100 may control resolution of the captured image to be lowered by merging a target pixel, a pixel positioned on the left of the target pixel, a pixel positioned below the target pixel, and a pixel positioned below a left portion of the target pixel (i.e., four pixels are merged like one pixel). As discussed above, this is only an example, and various pixels may be merged. Moreover, the number of pixels may be more or less than four.

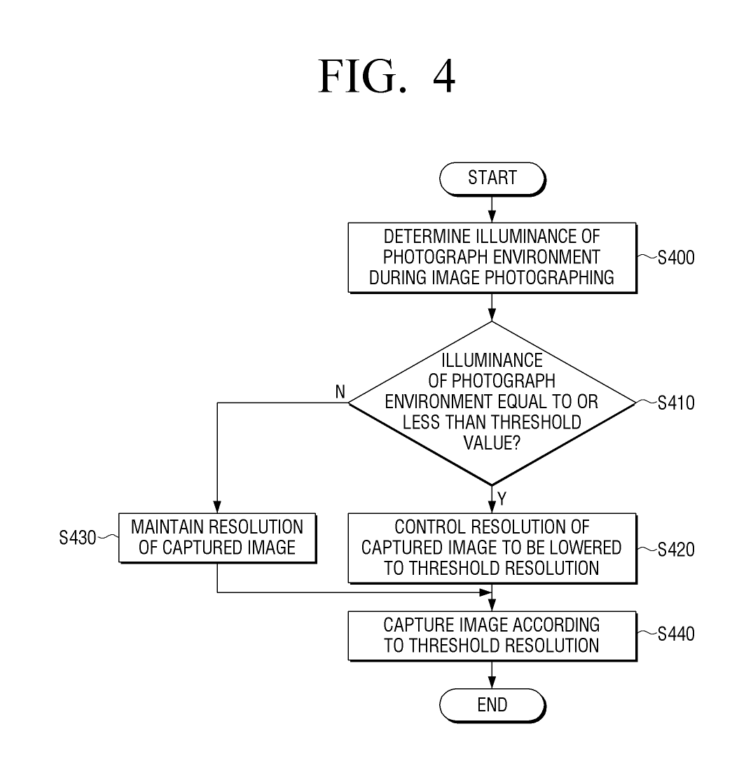

FIG. 4 is a flowchart of an image photographing method of the image photographing apparatus 100 according to an exemplary embodiment. First, the image photographing apparatus 100 determines an illuminance of a photograph environment during image photographing (S400).

The image photographing apparatus 100 determines whether the illuminance of an environment of the photograph (i.e., a photograph environment) is equal to or less than a threshold value (S410). That is, the image photographing apparatus 100 may determine the illuminance and the photograph environment, and when the illuminance is equal to or less than a threshold illuminance, the image photographing apparatus 100 may determine that an optical amount of the photograph environment is not sufficient and a current state is dark. The threshold illuminance may be preset.

As the determination result, when the illuminance of the photograph environment is equal to or less than a threshold value (S410-Y), the image photographing apparatus 100 controls a resolution of a captured image to be lowered to a threshold resolution (S420). For example, the image photographing apparatus 100 may adjust the resolution of the image to ½. The threshold resolution may be preset, or determined adaptively.

As the determination result, when the illuminance of the photograph environment is not equal to or less than the threshold value (S410-N), the image photographing apparatus 100 maintains the resolution of the captured image (S430). For example, the photographing apparatus 100 may maintain the resolution of the captured image at a maximum resolution. That is, the image photographing apparatus 100 may perform control to capture an image using all of a plurality of pixels included in the solid state image sensor device 112.

In addition, the image photographing apparatus 100 captures an image according to set resolution (S440). That is, upon determining that the illuminance of the photograph environment is equal to or less than the threshold value and controlling the resolution to be lowered, the image photographing apparatus 100 may capture an image according to the lowered resolution. In addition, upon determining the illuminance of the photograph environment exceeds a threshold value and determining that resolution is not to be controlled, the image photographing apparatus 100 may capture an image according to a current resolution. For example, the current resolution may be a maximum resolution.

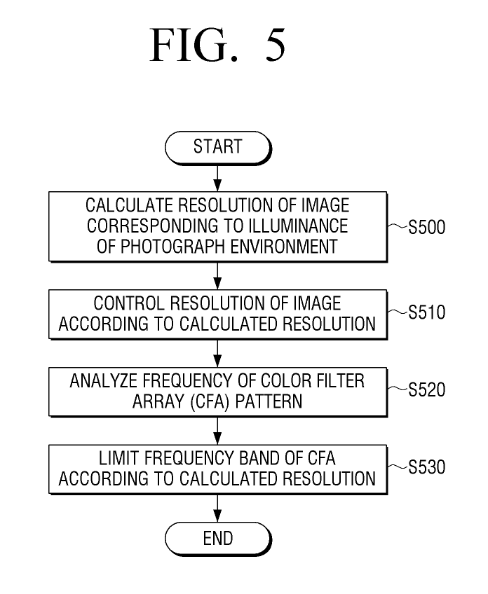

FIG. 5 is a flowchart illustrating a method of controlling a resolution and processing a signal according to the controlled resolution by the image photographing apparatus according to an exemplary embodiment.

First, the image photographing apparatus 100 calculates a resolution of an image corresponding to illuminance of an environment of the photograph (i.e., a photograph environment) (S500). That is, as described above, when the illuminance of the photograph environment is equal to or less than a threshold value, the image photographing apparatus 100 may control a resolution of the captured image to be lowered to a threshold resolution. The threshold resolution may be preset.

In addition, the image photographing apparatus 100 may control the resolution of the image to be proportionally lowered as the determined illuminance of the photograph environment decreases. For example, the image photographing apparatus 100 may control resolution to be lowered by 10% whenever an illuminance of the image is decreased by 10 lx (lux).

The aforementioned methods are merely exemplary, and thus the image photographing apparatus 100 may calculate a resolution of an image that is appropriate to be captured in the determined illuminance through various methods.

The image photographing apparatus 100 controls resolution of the image according to the calculated resolution (S510). In detail, the image photographing apparatus 100 may merge various pixels among a plurality of pixels included in the solid state image sensor device 112 to control a resolution of the captured image to be lowered. For example, the image photographing apparatus 100 may merge a plurality of neighboring pixels of the plurality of pixels included in the solid state image sensor 112. As one example, the image photographing apparatus 100 may control a resolution of the captured image to be lowered by merging a target pixel, a pixel positioned on the left of the target pixel, a pixel positioned below the target pixel, and a pixel positioned below a left portion of the target pixel.

When pixels are merged using the aforementioned methods to lower resolution, a Nyquist frequency may be changed causing aliasing. Accordingly, the image photographing apparatus 100 may limit a frequency band according to a ratio of the controlled resolution so as to prevent aliasing from occurring.

That is, the image photographing apparatus 100 analyzes a frequency of a color filter array (CFA) pattern (S520) and limits a frequency band of the CFA frequency according to the calculated resolution of the captured image (S530).

According to the aforementioned method, the image photographing apparatus 100 may acquire an image with optimum resolution without quality degradation.

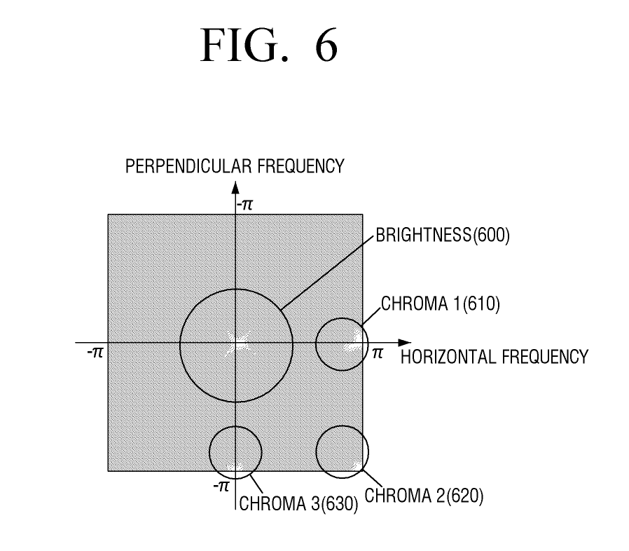

A method of acquiring an image with optimum resolution without quality degradation according to an illuminance of a photograph environment by the image photographing apparatus will be described in detail with reference to FIGS. 6 to 8.

FIG. 6 is a graph obtained by analyzing Bayer data and frequency characteristics according to an exemplary embodiment.

That is, when the image photographing apparatus 100 uses the solid state image sensor device 112 in which pixels are arranged according to a Bayer pattern, the image photographing apparatus 100 may analyze a signal output from pixels of the Bayer pattern to acquire a graph of the frequency characteristics illustrated in FIG. 6.

As illustrated in FIG. 6, the image photographing apparatus 100 may extract a brightness signal (Y signal) 600 in the graph for the frequency characteristics.

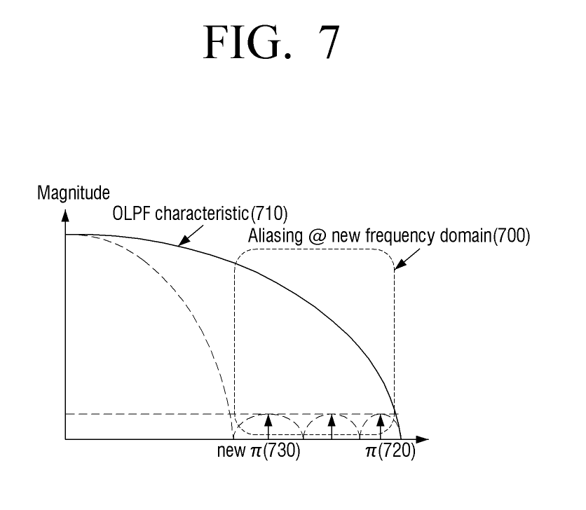

FIG. 7 is a graph for explanation of a new Nyquist frequency according to resolution control according to an exemplary embodiment. As illustrated in FIG. 7, when a plurality of pixels are merged to produce a lower resolution, a Nyquist frequency may be changed to cause aliasing 700.

According to an optical low pass filter (OLPF) characteristic 710, the aliasing 700 may occur, but the resolution may be lowered such that a maximum frequency may be changed to new π730 from π720. Accordingly, the image photographing apparatus 100 may extract an image signal with aliasing being removed.

That is, returning to FIG. 6, during extraction of the Y signal 600, the image photographing apparatus 100 may simultaneously limit a frequency band of the aliasing, which is calculated according to a ratio at which the resolution of an image is lowered, so as to acquire the image at a high SNR to ensure an optimum quality, appropriate for the resolution of the image.

As a result, the image photographing apparatus 100 may analyze frequency characteristic of Bayer data illustrated in FIG. 6 and may simultaneously block a frequency band according to the resolution control illustrated in FIG. 7.

Accordingly, a user may rapidly acquire an image with a high SNR to ensure optimum quality, and use the image photographing apparatus 100 with low power consumption.

The aforementioned case in which a frequency characteristic of Bayer data is analyzed and a frequency band is simultaneously blocked is merely exemplary, and thus the image photographing apparatus 100 may block a frequency band according to a resolution control illustrated in FIG. 7 before or after analysis of the frequency characteristic of Bayer data illustrated in FIG. 6.

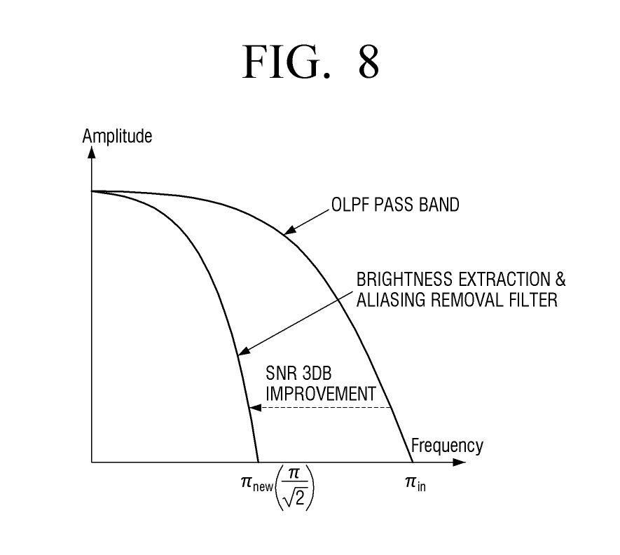

FIG. 8 is a graph for explanation of an effect of limiting of a frequency band according to an exemplary embodiment.

As described above, the frequency characteristic of Bayer data may be analyzed and a new Nyquist frequency may be calculated according to a control of a resolution of the captured image, and thus the image photographing apparatus 100 may calculate a low pass filter (LPF) coefficient for limiting the frequency band.

In addition, the image photographing apparatus 100 may apply the calculated LPF coefficient to a LPF to remove aliasing and to change a maximum frequency, thereby acquiring an image with an improved SNR.

In particular, FIG. 8 is a diagram illustrating a case in which a resolution of a captured image is lowered to ½ according to a determined illuminance, according to an exemplary embodiment. As illustrated in FIG. 8, as resolution of the image is lowered to ½, the image photographing apparatus 100 may acquire an image with an SNR that is experimentally improved by 3 dB.

The aforementioned image photographing method according to various exemplary embodiments may be coded in software that is stored in a non-transitory readable medium and executed by a computer, processor or integrated circuit. The non-transitory readable medium may be installed and used in various apparatuses.

The non-transitory computer readable media refers to a medium that semipermanently stores data and is readable by a device instead of a medium that stores data for a short time period, such as a register, a cache, a memory, etc. In detail, the aforementioned programs may be stored and provided in the non-transitory computer readable media such as a compact disc (CD), a digital versatile disc (DVD), a hard disc, a Blu-ray disc, a Universal Serial Bus (USB), a memory card, a read only memory (ROM), etc.

According to the aforementioned various exemplary embodiments, even if illuminance of a photograph environment is lowered, a user may capture an image while maintaining image quality of an image captured in high illuminance.

In addition, according to another exemplary embodiment, the user may control a resolution irrespective of a signal processing order of the captured image, and thus use an image photographing apparatus with reduced power consumption.

The foregoing embodiments and advantages are merely exemplary and are not to be construed as limiting. Also, the description of the exemplary embodiments is intended to be illustrative, and not to limit the scope of the claims, and many alternatives, modifications, and variations will be apparent to those skilled in the art.

What is claimed is:

1. An image photographing method of an image photographing apparatus, the method comprising:
determining an illuminance of a photograph environment during image photographing; and
controlling a resolution of a captured image according to the determined illuminance.

2. The image photographing method as claimed in claim 1, wherein the controlling comprises controlling the resolution of the captured image to be lowered to a threshold resolution in response to the determined illuminance being equal to or less than a first threshold value.

3. The image photographing method as claimed in claim 1, wherein the controlling comprises controlling the resolution of the captured image to be proportionally lowered as the determined illuminance decreases.

4. The image photographing method as claimed in claim 1, wherein the image photographing apparatus comprises an image sensor, and the controlling the resolution comprises merging a subset of a plurality of pixels included in the image sensor.

5. The image photographing method as claimed in claim 1, wherein the controlling comprises:
determining a resolution of the captured image corresponding to the determined illuminance of the photograph environment;
analyzing a frequency of a color filter array (CFA) pattern used to capture the captured image; and
limiting a frequency band of the CFA pattern according to the determined resolution.

6. The image photographing method as claimed in claim 1, wherein the determining comprises analyzing the captured image and determining the illuminance of the photograph environment according to a result of the analyzing.

7. The image photographing method as claimed in claim 1, wherein the image photographing apparatus comprises an illuminance sensor, and the determining comprises determining the illuminance of the photograph environment using he illuminance sensor.

8. The image photographing method as claimed in claim 1, further comprising:
determining a signal to noise ratio (SNR) of the captured image; and
controlling the resolution of the image in response to the SNR of the image being greater than or equal to a threshold value.

9. The image photographing method as claimed in claim 8, wherein the controlling comprises lowering the resolution of the captured image to a threshold resolution in response to the SNR of the image being greater than or equal to a first threshold value.

10. The image photographing method as claimed in claim 1, further comprising storing the controlled resolution of the captured image in association with the determined illuminance.

11. The image photographing method as claimed in claim 1, wherein the merging comprises merging a preset number of neighboring pixels of the plurality of pixels included in the image sensor.

12. An image photographing apparatus comprising:
a photographing module configured to capture an image; and
a controller configured to determine an illuminance of a photograph environment during photographing of the image, and to control a resolution of the captured image according to the determined illuminance.

13. The image photographing apparatus as claimed in claim 12, wherein the controller is configured to control the resolution of the captured image to be lowered to a threshold resolution in response to the illuminance being equal to or less than a first threshold value.

14. The image photographing apparatus as claimed in claim 12, wherein the controller is configured to control the resolution of the captured image to be proportionally lowered as the determined illuminance decreases.

15. The image photographing apparatus as claimed in claim 12, wherein the photographing module comprises an image sensor comprising a plurality of pixels; and
the controller is configured to control the resolution of the captured image to be lowered by merging a subset of the plurality of pixels included in the image sensor.

16. The image photographing apparatus as claimed in claim 12, wherein the controller is configured to determine a resolution of the image corresponding to the determined illuminance of the photograph environment, analyze a frequency of a color filter array (CFA) pattern used to capture the image, and limit a frequency band of the CFA pattern according to the determined resolution.

17. The image photographing apparatus as claimed in claim 12, wherein the controller is configured to analyze the captured image and determine the illuminance of the photograph environment according to the analysis result.

18. The image photographing apparatus as claimed in claim 12, further comprising an illuminance sensor,
wherein the controller is configured to determine the illuminance using the illuminance sensor.

19. The image photographing apparatus as claimed in claim 12, wherein the controller is configured to determine a signal to noise ratio (SNR) of the captured image and control the resolution of the image in response to the SNR of the image being greater than or equal to a threshold value.

20. The image photographing apparatus as claimed in claim 19, wherein the controller is configured to lower the resolution of the captured image to a threshold resolution in response to the SNR of the image being greater than or equal to a first threshold value.

21. The image photographing apparatus as claimed in claim 12, further comprising a storage,
wherein the controller is configured to control the storage to store the controlled resolution of the captured image in association with the determined illuminance.

22. The image photographing apparatus as claimed in claim 11, wherein the controller is configured to merge a preset number of neighboring pixels of the plurality of pixels included in the image sensor.
